(19) United States
(12) Patent Application Publication
(10) Pub. No.: US 2006/0085762 A1
(43) Pub. Date: Apr. 20, 2006

(54) Display device with a detechable command input unit

(75) Inventors: Kuan-Hong Hsieh, Tu-Cheng (TW); Xin Lu, Shenzhen (CN); Xiao-Guang Li, Shenzhen (CN); Zhong-Wu Tian, Shenzhen (CN); Hsueh-Tsung Lu, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/250,272

(22) Filed: Oct. 14, 2005

(30) Foreign Application Priority Data
Oct. 15, 2004 (TW) 93131360

(51) Int. Cl. G06F 17/00

(52) U.S. Cl. 715/810

(57) ABSTRACT

A display device includes a main body and a housing. The main body includes a control unit. The housing includes a command input unit associated with the housing. The command input is replaceable piece of equipment. The command input unit includes a plurality of pins for generating the control signals in response to operations of a user, each of the pins being designated with an identifier. The number of pins is dependent on the particular command input unit selected by a user. The control unit identifies the control signals and performs the corresponding functions through the identifiers. The functions include turning on the display device, turning off the display device, obtaining corresponding OSD data, displaying an OSD menu, and adjusting parameters of the display device.

### BACKGROUND OF THE INVENTION

1. Field of the Invention

The present invention relates to display devices with detachable command input units, and particularly to a display device having a detachable command input unit that can be conveniently replaced if desired.

2. General Background

A typical electronic display device such as a computer monitor includes a main body and a housing. A manufacturer of computer monitors may provide several different models of computer monitor. Most of the components of the different models of computer monitor are the same. Some differences may include an appearance of the housing and a type of a command input unit. Referring to FIG. 2, a typical LCD (liquid crystal display) includes a main body 10 and a housing 20. The main body 10 includes a micro-programmed control unit (MCU) 11, a read only memory (ROM) 12, a scaler 13, an on-screen display (OSD) unit 14, an analog/digital (A/D) converter 15, a display unit 16, and a command input unit 21. The housing 20 generally functions only as a cover for covering the main body 10.

Recently, with the rapid increase of computer users, the demand for individually unique command input units has significantly increased. For example, some users prefer knobs on a command input unit, whereas other users prefer keys or touch pads on the command input unit. Further, some users prefer fewer keys on a smaller command input unit, whereas other users prefer more keys on a more comprehensive command input unit. However, when the command input unit is contained in the main body of the LCD, a manufacturer of LCDs has to configure an entire unique model of LCD for each type of different command input unit. Each time a new type of command input unit is to be manufactured, time consuming and expensive redesigning and remanufacturing are required.

Therefore, a hitherto unaddressed need exists in the industry to address the aforementioned deficiencies and inadequacies.

### SUMMARY

The present invention provides a display device having a detachable command input unit. The command input unit is associated with a housing but is detachable from the main body of the display device. Therefore, the command input unit associated with the housing can be independently designed or/and replaced according to the user's individually unique demand, whereas the same components of the display device can be manufactured in large scale, thereby efficiently reducing manufacture time and cost.

The display device includes a main body and a housing. The main body includes means for receiving a video signal, an on-screen display (OSD) component for storing a plurality of OSD data, a control unit, a memory and a display unit. The housing includes a command input unit associated with the housing. The command input is replaceable. The command input unit generates one or more control signals. The memory stores a plurality of programs. The control unit executes the programs to identify the control signals from the command input unit, and to control the display device to perform corresponding functions in response to the control signals. The functions include turning on the display device, turning off the display device, obtaining corresponding OSD data from the OSD unit, displaying an OSD menu, and adjusting parameters of the display device.

The programs includes a plurality of subprograms for identifying the control signals from the command input unit, obtaining corresponding OSD data from the OSD unit, displaying the OSD menu, and adjusting parameters of the display device. The command input unit is replaceable piece of equipment. The command input unit includes a plurality of pins for generating the control signals in response to operations of a user, each of the pins being designated with an identifier. The number of pins is dependent on the particular command input unit selected by a user. The control unit identifies the control signals and performs the corresponding functions through the identifiers. The quantity of the pins is dependent on the command input unit.

Other systems, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

FIG. 1 is a block diagram of hardware infrastructure of a liquid crystal display (LCD) with a detachable housing according to a preferred embodiment of the present invention; and

FIG. 2 is a block diagram of hardware infrastructure of a conventional LCD.

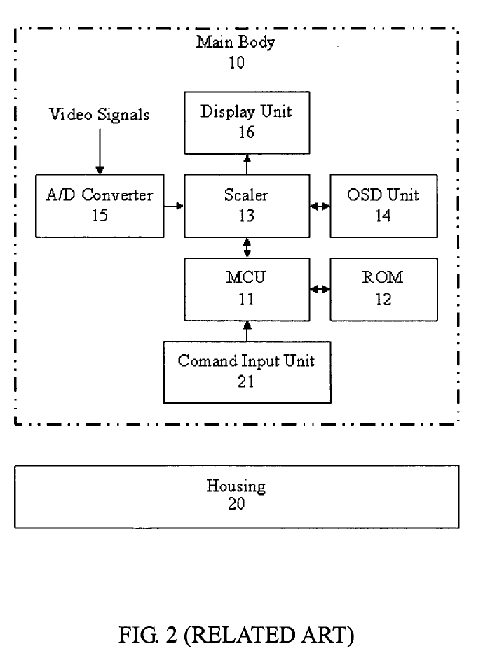

### DETAILED DESCRIPTION OF THE PREFERRED EMBODIMENTS

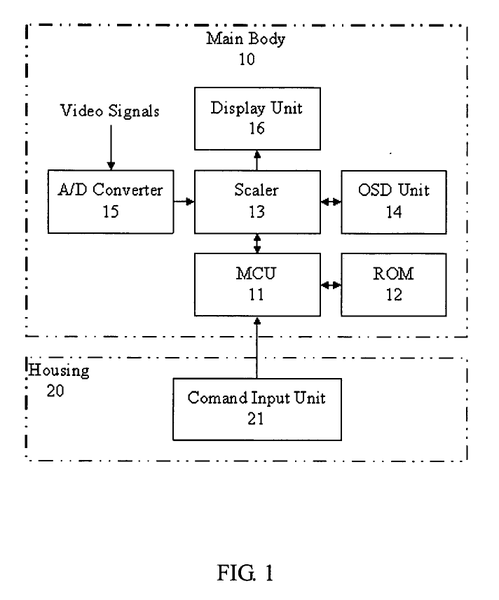

A display device in accordance with a preferred embodiment of the present invention includes a detachable command input unit. The display device may be, for example, a cathode ray tube (CRT) monitor, a liquid crystal display (LCD), or another similar kind of display device. For simplicity, the preferred embodiment will be described hereinbelow in relation to an LCD. However, the present invention should not be construed as being limited to the embodiment set forth herein. The following detailed description of the embodiment is made with reference to the attached FIG. 1.

FIG. 1 is a block diagram of hardware infrastructure of an LCD according to the preferred embodiment of the present invention. The LCD includes a main body 10 and a housing 20. The main body 10 includes a micro-programmed control unit (MCU) 11, a read only memory (ROM) 12, a scaler 13, an on-screen display (OSD) 14, an analog/digital (A/D) converter 15, and a display unit 16. The housing 20 includes a command input unit 21. The command input unit 21 is a replaceable piece of equipment.

The command input unit 21 generates control signals in response to an operation of a user. The operation can be turning on the LCD, turning off the LCD, displaying an OSD menu, adjusting any of various parameters of the LCD, etc. The parameters of the LCD mainly include volume level, color levels, lightness, contrast, vertical position, horizontal position, and so on. The OSD unit 14 stores a plurality of OSD data. When receiving a control signal to displaying the OSD menu, the MCU 11 obtains corresponding OSD data from the OSD unit 14, and generates a graphics signal for displaying the OSD menu.

The A/D converter 15 converts a video signal from a computer (not shown) into a digital signal. The scaler 13 can transmit the digital signal directly to the display unit 16. Moreover, the scaler 13 can overlap the digital signal and the graphics signal to generate an overlapped video signal. The display unit 16 can display either the video signal or the overlapped video signal on a screen display (not shown) of the LCD. Thereupon, the display unit 16 displays an overlapped image, including a video image and an OSD menu, on the screen display, according to the overlapped video signal. This is done when the user initially operates the command input unit 21 to display the OSD menu. Subsequently, the scaler 13 can adjust any of the parameters of the LCD under the control of the MCU 11, according to a corresponding control signal sent from the command input unit 21. The command input unit 21 can adopt buttons, knobs, touch pads, or any other suitable type of manipulable objects as user interfaces. Corresponding to the user interfaces, the command input unit 21 includes a plurality of pins for generating control signals. The number of pins is the same as the number of user interfaces. Therefore different kinds of command input units 21 possess different types and numbers of user interfaces, and employ different numbers of pins. Each pin of the command input unit 21 is designated with an identifier, whereby the MCU 11 can identify the operation of the user and perform the corresponding function. The corresponding function may, for example, be turning on the LCD, turning off the LCD, displaying the OSD menu, and adjusting the parameters of the LCD.

The ROM 12 stores a plurality of programs executed by the MCU 11. Each of the programs corresponds to a particular function, and includes a plurality of subprograms for performing the particular function. Therefore, in the preferred embodiment, there are a plurality of subprograms for identifying the control signals from the command input unit 21, turning on/off the LCD, obtaining OSD data from the OSD unit 14, displaying the OSD menu, and adjusting the parameters of the LCD, all in response to the respective control signals.

It should be emphasized that the above-described embodiments, including preferred embodiments, are merely possible examples of implementations, and are merely set forth for a clear understanding of the principles of the invention. Many variations and modifications may be made to the above-described embodiments without departing substantially from the spirit and principles of the invention. All such modifications and variations are intended to be included herein within the scope of this disclosure and the present invention, and be protected by the following claims.

We claim:

1. A display device comprising a main body and a housing, the main body comprising means for receiving a video signal, an on-screen display (OSD) component for storing a plurality of OSD data, a control unit, a memory, and a display unit, wherein:
the housing comprises a command input unit associated with the housing, the command input unit being for generating one or more control signals;
the memory stores a plurality of programs;
the control unit executes the programs to identify the control signals from the command input unit, and to control the display device to perform corresponding functions in response to the control signals.

2. The display device according to claim 1, wherein the functions comprise turning on the display device, turning off the display device, obtaining corresponding OSD data from the OSD unit, displaying an OSD menu, and adjusting parameters of the display device.

3. The display device according to claim 1, wherein the command input is a replaceable piece of equipment.

4. The display device according to claim 1, wherein the programs comprise a plurality of subprograms for identifying the control signals from the command input unit, obtaining corresponding OSD data from the OSD unit, displaying the OSD menu, and adjusting parameters of the display device.

5. The display device according to claim 3, wherein the command input unit includes a plurality of pins for generating the control signals in response to operations of a user, each of the pins being designated with an identifier.

6. The display device according to claim 4, wherein the control unit identifies the control signals and performs the corresponding functions through the identifiers.

7. The display device according to claim 4, wherein the command input is a replaceable piece of equipment, and the number of pins is dependent on the particular command input unit selected by a user.

8. A display device comprising:
a main body having inner space to accommodate electronic components therein so as to perform display of said display device via said electronic components; and
a housing enclosing said main body and spatially isolating said electronic components from an outside of said display device, said housing comprising a command input unit installed exclusively in said housing and removably, electrically connectable with at least one of said electronic components of said main body when said housing is assembled with said main body, said command input unit capable of exposing to said outside of said display device to accept user-control operation and capable of generating independently a control signal further transmissible to said at least one of said electronic components according to said user-control operation so as to control said display of said display device.

9. The display device according to claim 8, wherein said command input unit is removable together with said housing when said housing is replaced by another housing having another command input unit arranged differently from said command input unit.

10. A method to control a display device, comprising the steps of:
installing a command input unit in a housing of a display device removably enclosing a main body of said display device accommodating other electronic components therein in order to perform display of said display device;
electrically connecting said command input unit with said other electronic components when said housing and said main body are assembled as said display device; and
independently generating control signals by means of said command input unit in response of accepting user-control operation on said command input unit so as to transmit said control signals to said other electronic components for performing said display of said display device.

11. The method according to claim 10, further comprising the step of replacing said housing by another housing having another command input unit arranged differently from said command input unit of said housing.
